(19) United States
(12) Patent Application Publication
(10) Pub. No.: US 2014/0175015 A1
(43) Pub. Date: Jun. 26, 2014

(54) WATER PURIFICATION METHOD

(71) Applicant: FUJIFILM Corporation, Tokyo (JP)

(72) Inventor: Taisei NISHIMI, Kanagawa (JP)

(73) Assignee: FUJIFILM Corporation, Tokyo (JP)

(21) Appl. No.: 14/133,956

(22) Filed: Dec. 19, 2013

Related U.S. Application Data
(63) Continuation of application No. PCT/JP2012/064498, filed on Jun. 6, 2012.

(30) Foreign Application Priority Data
Jun. 20, 2011 (JP) 2011-136206

(51) Int. Cl. C02F 1/42; C02F 1/52

(52) U.S. Cl. CPC C02F 1/42; C02F 1/5236
USPC 210/667

(57) ABSTRACT

A water purification method comprising adding a purification agent to water having a contaminant concentration of 1 μg/L to 10 g/L, the purification agent containing an adsorbent having an average particle size of 100 nm to 500 μm, an iron-based flocculant, and an alkaline substance; causing the adsorbent to adsorb at least a part of the contaminants in water; settling the adsorbent with the adsorbed contaminants by the iron-based flocculant; and removing the sediment from water, wherein the purification agent is added in an amount of 0.01 g to 20 g per liter of water, can purify contaminated water conveniently and efficiently.

### CROSS-REFERENCE TO RELATED APPLICATIONS

This application is a continuation application of International Application No. PCT/JP2012/064498, filed Jun. 6, 2012, which in turn claims the benefit of priority from Japanese Application No. 2011-136206, filed Jun. 20, 2011, the disclosures of which Applications are incorporated by reference herein in their entirety.

### BACKGROUND OF THE INVENTION

1. Field of the Invention

The present invention relates to a technique for the purification of contaminated water, and to a method for efficiently purifying water.

2. Background Art

The 21st century is seen as the age of water, and is facing serious challenges, including water shortage, water contamination, and conflict over water. The World Water Development Report published on Mar. 5, 2003 warns that a serious water shortage will occur by the middle of this century, and that, in the worst case, 7 billion people will be affected across 60 countries.

Problems over water are not just future problems expected to occur by the middle of this century, but today's social problems. A safe water supply is not always available in many developing countries. For example, the WHO Drinking Water Guidelines presents the desirable guideline value of 10 ppb or less for the concentration of inorganic compound arsenic in drinking water (Non-Patent Document 1). However, there are reports that the arsenic dissolved in well water in countries such as Bangladesh, India, and Cambodia can far exceed this reference value, and poses serious health risks to the local people. These people are also at serious health risk caused by contamination of well water with chemicals such as fluorine deriving from nature, and hexavalent chromium deriving from factories.

Inorganic compounds such as arsenic are merely one example of harmful substances contaminating well water and river water in developing countries. Organic compounds such as pesticides, agrichemicals, pigments, and dyes dissolved in water are also known to cause environmental contamination and health hazards.

The problems concerning safe water supply are not just the problems of developing countries. In Japan today, there is an urgent need to establish a technique for efficiently removing iodine, cesium, strontium, and other radioisotopes from water contaminated with radioactive compounds deriving from nuclear power plants.

Developing a technique for the removal of harmful inorganic compounds and organic compounds from water thus remains as a big social challenge. One way of solving the foregoing problems is to use a water purification system that makes use of a reverse osmosis membrane. However, the reverse osmosis membrane system is expensive and requires power, and cannot be easily used in rural areas of developing countries where power is not easily available. There is accordingly a need for the development of a technique that can be used in places where there is no electricity, and that can remove inorganic and organic materials from water at low cost, without using electricity.

A coagulation and flocculation technique that uses an inorganic flocculant and a polymer flocculant is known as a method of removing harmful substances from water without using electricity (Non-Patent Document 2). Several types of water purification agents are proposed for use in such a coagulation and flocculation technique (Patent Documents 1 and 2), and are actually used in underdeveloped countries (Non-Patent Document 3). It is, however, difficult to provide sufficient effect for the removal of water-soluble organic compounds with the coagulation and flocculation technique alone.

Using an adsorbent such as activated carbon is known to be effective for the removal of water-soluble organic compounds from water, and such adsorbents are actually used in sewerage treatment plants and elsewhere (Non-Patent Document 4). The adsorbent used is typically granular or fibrous, and can easily be separated from water after the adsorbing procedures. However, because such adsorbents have a small surface area per unit volume, there is difficulty in adsorbing substances in a short time period and with high efficiency. When used in a fine powdery form, the adsorbent can have an increased surface area per unit volume, and can efficiently adsorb substances in a short time period. A procedural drawback, however, is that the separation of the adsorbent from water becomes difficult.

There is a report of a water purification method that uses a flocculant and an adsorbent in combination. Patent Document 3 discloses a water purification method in which a rare-earth compound-containing adsorbent is brought into contact with a selenium-containing drainage water, and a flocculant is introduced for flocculation. However, because this technique necessarily uses the expensive rare metal rare-earth compounds in relatively large quantities, it is difficult to inexpensively and conveniently obtain drinking water with this technique.

Patent Document 4 discloses an adsorption-flocculation wastewater treatment agent configured to treat wastewater with an acidic chemical such as polyaluminium chloride, aluminum oxide, ferrous sulfate, and ferric chloride; an alkaline chemical such as hydrated lime, calcium carbonate, magnesium carbonate, sodium carbonate, and a pulverized oyster shell; a porous adsorbent such as artificial zeolite, natural zeolite, silicon dioxide, and activated carbon; and a flocculant such as a polymer flocculant, and foamed glass. However, this technique is intended to purify highly contaminated water such as concrete laitance, and drainage from ceramic plants with large-scale facilities until the water is pure enough to be disposed as an effluent, and cannot be easily used to inexpensively and conveniently obtain drinking water.

Patent Document 5 discloses a water treatment flocculant prepared by mixing and applying an aluminum-based flocculant to a carbon-based substance at an aluminum-based flocculant/carbon-based substance weight ratio of 0.05 to 1. However, this technique cannot provide good ease of flocculation, and, because of the aluminum-based flocculant that produces a precipitate only in a narrow pH range, cannot easily remove the precipitate, and is applicable only in a narrow pH range. It is therefore difficult with this technique to inexpensively, conveniently, and quickly obtain drinking water.

### CITATION LIST

### Patent Documents

Patent Document 1: U.S. Pat. No. 6,827,874
Patent Document 2: Japanese Patent No. 4490795
Patent Document 3: JP-A 2007-326077
Patent Document 4: JP-A 2009-248006
Patent Document 5: JP-A 7-328322

### Non-Patent Documents

Non-Patent Document 1: Guidelines for Drinking-Water Quality, Volume 1, 3rd ed., World Health Organization (2006).
Non-Patent Document 2: The NALCO Water Handbook, Second Edition, F. N. Kemmer, ed., McGraw-Hill (1988).
Non-Patent Document 3: Ivan Amato, Chem. Eng. News, vol. 84 (16), pp 39-40 (2006)
Non-Patent Document 4: Activated Carbon Adsorption for Wastewater Treatment, J. R. Perrich. ed., CRC Press (1981).

### SUMMARY OF THE INVENTION

### Problems That the Invention Is to Solve

As described above, it has been difficult to inexpensively, conveniently, and quickly obtain drinking water from relatively less contaminated water containing various contaminants without using electricity. Accordingly, there is a need for a novel water purification method.

It is accordingly an object of the present invention to provide a technique for obtaining drinking water whereby well water, river water, lake water, and the like containing relatively low, concentrations of contaminants are inexpensively and conveniently purified with high efficiency (in a short time period) under no electricity conditions.

Another object of the present invention is to provide a technique that can remove radioactive compounds from sea water, cooling water, tap water, and the like dissolving trace amounts of radioisotopes such as iodine, cesium, and strontium.

### Means for Solving the Problems

The present inventor completed the present invention on the basis of the finding that harmful compounds in water can be more efficiently and quickly removed without power when a fine powdery adsorbent dispersed in water is used to adsorb water-soluble harmful compounds, and flocculated and settled under the effect of an iron-based inorganic flocculant, compared to the harmful compound removal performance of the adsorbent or the iron-based inorganic flocculant alone, or the harmful compound removal performance of the adsorbent and the iron-based inorganic flocculant simply combined together.

The foregoing problems are solved by the following means.

[1] A water purification method comprising:

adding a purification agent to water having a contaminant concentration of 1 μg/L to 10 g/L, the purification agent containing an adsorbent having an average particle size of 100 nm to 500 μm, an iron-based flocculant, and an alkaline substance;

causing the adsorbent to adsorb at least a part of the contaminants in water;

settling the adsorbent with the adsorbed contaminants under the effect of a water-insoluble ferric hydroxide produced by reaction of the iron-based flocculant and the alkaline substance; and

removing the sediment from water,

wherein the purification agent is added in an amount of 0.01 g to 20 g per liter of water.

[2] The water purification method of [1], wherein the proportion of the adsorbent in the total mass of the purification agent is 40 mass % to 95 mass %.

[3] The water purification method of [1] or [2], wherein a water-soluble polymer is added together with the purification agent or separately from the purification agent.

[4] The water purification method of any one of [1] to [3], wherein the sediment is removed from water by filtration with a fabric or sand.

[5] The water purification method of any one of [1] to [4], wherein the adsorbent contains at least one of activated carbon and zeolite, and adsorbs at least an organic compound in water.

[6] The water purification method of any one of [1] to [5], wherein the adsorbent contains at least one of zeolite, laminar silicate, cation exchange resin, and chelate resin, and adsorbs at least a cationic compound in water.

[7] The water purification method of any one of [1] to [6], wherein the adsorbent contains at least one of hydrotalcite, schwertmannite, and anion exchange resin, and adsorbs at least an anionic compound in water.

[8] The water purification method of any one of [1] to [7], wherein the adsorbent contains at least one of hydroxyapatite, alumina, and zirconia, and adsorbs at least fluorine in water.

[9] The water purification method of any one of [1] to [8], wherein the adsorbent contains at least one of activated carbon, alumina, hydrotalcite, and schwertmannite, and adsorbs at least arsenic in water.

[10] The water purification method of any one of [1] to [9], wherein the adsorbent contains at least one of activated carbon, zeolite, ferric hydroxide, hydrotalcite, and bentonite, and adsorbs at least hexavalent chromium in water.

[11] The water purification method of any one of [1] to [10], wherein the adsorbent contains at least one of zeolite, hydrotalcite, boehmite, apatite, and crosslinked cyclodextrin-containing polymer, and adsorbs at least iodine in water.

[12] The water purification method of any one of [1] to [11], wherein the adsorbent contains at least one of activated carbon, zeolite, mordenite, vermiculite, iron ferrocyanide, and manganese oxide, and adsorbs at least cesium in water.

[13] The water purification method of any one of [1] to [12], wherein the adsorbent contains at least one of activated carbon, zeolite, polyantimonic acid, vermiculite, iron ferrocyanide, and montmorillonite, and adsorbs at least strontium in water.

[14] The water purification method of any one of [1] to [13], wherein the adsorbent is used in a combination of two or more.

[15] The water purification method of any one of [1] to [14], wherein the iron-based flocculant contains at least one of ferric sulfate, ferric chloride, polyferric sulfate, and ferrous sulfate.

[16] The water purification method of any one of [1] to [15], wherein the iron-based flocculant and the alkaline substance are each a powder having an average particle size of 100 nm to 500 μm.

[17] The water purification method of any one of [1] to [16], wherein an oxidizing agent is added together with the purification agent or separately from the purification agent.

[18] The water purification method of any one of [1] to [17], wherein the water is brought to pH 5.0 to pH 9.0 after removing the sediment.

[19] The water purification method of any one of [1] to [18], wherein the purified water is used as drinking water.

### Advantageous Effects of the Invention

The present invention can provide a method for conveniently and efficiently purifying contaminated water. The method of the present invention is useful not only as a method for purifying contaminated water and obtaining daily water and drinking water in less-developed countries, but as a method for treating drained water from industrial plants and electrical power plants.

### MODE FOR CARRYING OUT THE INVENTION

The present invention is described below, in detail. As used herein, the numerical ranges defined with “to” are intended to be inclusive of the numbers specified before and after “to” as the lower limit and the upper limit.

The present invention is concerned with a water purification method that includes:

adding a purification agent to water having a contaminant concentration of 1 μg/L to 10 g/L, the purification agent containing an adsorbent having an average particle size of 100 nm to 500 μm, an iron-based flocculant, and an alkaline substance;

causing the adsorbent to adsorb at least a part of the contaminants in water;

settling the adsorbent with the adsorbed contaminants under the effect of a water-insoluble ferric hydroxide produced by reaction of the iron-based flocculant and the alkaline substance; and

removing the sediment from water,

wherein the purification agent is added in an amount of 0.01 g to 20 g per liter of water.

Using a small-particle-size adsorbent can improve adsorption performance, and the efficiency of adsorbing contaminants from water. However, removal of such a fine particulate adsorbent itself from water is difficult to achieve. The present invention can improve contaminant adsorption efficiency by using a fine particulate adsorbent having an average particle size of a predetermined range. Further, because the adsorbent is used with an iron-based flocculant and an alkaline substance, the adsorbent that has adsorbed the contaminant can flocculate and settle under the effect of a water-insoluble ferric hydroxide produced by reaction of the iron-based flocculant and the alkaline substance. The sediment resulting from the flocculation of the adsorbent can easily be removed by ordinary procedures such as filtration. The present invention can thus inexpensively, conveniently, and quickly (efficiently) purify contaminated water containing various contaminants, and provide water of sufficiently low contaminant concentration usable as drinking water. The present invention also can purify industrial and other contaminated water containing various contaminants, and reduce the contaminant concentration to drainable levels.

The contaminated water subject to the method of the present invention has a contaminant weight of 1 μg to 10 g, more preferably less than 10 g, further preferably 5 μg to 1 g, even more preferably 10 μg to 0.1 g per liter of untreated water.

Water containing contaminants above these concentration ranges cannot easily be inexpensively, conveniently, and quickly purified into drinkable water without using electricity. On the other hand, water containing contaminants in the foregoing concentration ranges can be purified by the method of the present invention, and the contaminants can be removed and reduced to levels that can make the water usable as daily water and drinking water, without further purification processes.

Examples of water containing contaminants in the foregoing concentration ranges include well water, river water, and lake water containing low-concentration contaminants. The method of the present invention is suited for purifying these waters. The present invention also can be used for the purification of contaminated water containing higher concentrations of contaminants, such as waste fluid from livestock barns, human waste, septic tank sludge, landfill leachate, plating drainage, mine drainage, oil polluted water, drained water from pulp plants, cement drainage water, and hydrofluoric acid-containing washing liquid from semiconductor manufacturing plants. In this case, the purification method of the present invention is preferably used after bringing the contaminant concentration to the foregoing ranges by using other methods, for example, by performing one or more purification procedures with an adsorbent of larger particle size.

The present invention uses a purification agent that contains the adsorbent having an average particle size of the predetermined range, the iron-based flocculant, and the alkaline substance. Effective contaminant removal is difficult with small amounts of the purification agent added to the contaminated water. On the other hand, adding the purification agent in large amounts generates large amounts of contaminant-containing sediment (hereinafter, also referred to as “sludge”), though it effectively removes the contaminants. It is therefore preferable in the present invention that the purification agent be added in 0.01 g to 20 g, more preferably less than 20 g, further preferably 0.05 g to 5 g, even more preferably 0.1 g to 1 g per liter of water containing contaminants.

One of the features of the present invention is that the fine particulate adsorbent having an average particle size of the predetermined range is used. Using a fine particulate adsorbent of small average particle size improves adsorption performance, but makes it difficult to remove the adsorbent itself from water. In the present invention, the adsorbent is used with the iron-based flocculant and the alkaline substance, and the adsorbent that has adsorbed contaminants flocculates with a water-insoluble ferric hydroxide produced by reaction of the iron-based flocculant and the alkaline substance, and settles under its own weight. The sediment surrounded by the flocculant, and existing as large particles is easily removed from water by using ordinary procedures such as filtration. When the proportion of the iron-based flocculant with respect to the adsorbent is small, flocculation does not occur effectively, and collection of the purified water becomes difficult. On the other hand, large amounts of contaminant-containing sludge are generated when the proportion of the iron-based flocculant with respect to the adsorbent is large, though the adsorbent can be effectively settled and removed. It is therefore preferable that the proportion of the adsorbent be 40 mass % to 95 mass %, more preferably 50 mass % to 92.5 mass %, further preferably 60 mass % to 90 mass % with respect to the total mass of the purification agent of the present invention, specifically the purification agent containing the adsorbent, the iron-based flocculant, and the alkali.

In the present invention, the contaminants in contaminated water are removed in the state of being adsorbed by the adsorbent. However, for example, the contaminants in water may be directly settled by being surrounded by the water-insoluble ferric hydroxide produced by reaction of the iron-based flocculant and alkaline substance, and removed from water in the form of sediment that does not contain the adsorbent, provided that it does not affect the advantages of the present invention. Further, some of the adsorbents that have adsorbed the contaminants may not be settled but removed together with the sediment by a subsequent process such as filtration, provided that it does not affect the advantages of the present invention.

The adsorbent usable in the present invention includes inorganic compounds, organic compounds, and metal complexes. Examples of the inorganic compounds usable as the adsorbent in the present invention include activated carbon, zeolite, alumina, zirconia, manganese oxide, magnesium aluminate, polyantimonic acid, laminar silicate, boehmite, apatite, hydroxyapatite, hydrotalcite, and schwertmannite. Examples of the organic compounds usable as the adsorbent in the present invention include cation-exchange resin, anion-exchange resin, and chelate exchange resin. Examples of the metal complexes usable as the adsorbent in the present invention include iron ferrocyanide, magnesium manganese sulfate, porphyrin metal complexes, phthalocyanine metal complexes, Schiff base metal complexes, iminodiacetic acid metal complexes, and porous metal complexes. In the present invention, the adsorbent may be used either alone or in a combination of two or more.

In the present invention, the particle size of the adsorbent is preferably 10 nm to 500 μm, more preferably less than 500 μm, further preferably 50 nm to 100 μm, even more preferably 75 nm to 50 μm, particularly preferably 100 nm to 15 μm. With an adsorbent particle size below these ranges, it becomes difficult to flocculate and settle the adsorbent particles under the effect of the flocculant. An adsorbent particle size above these ranges makes it difficult to disperse the adsorbent throughout water, and to quickly and effectively adsorb the target substance.

The adsorbent is preferably a porous body having surface pores. According to IUPAC definition, pore size is classified into micropore with a diameter of 2 nm or less, mesopore with a diameter of 2 to 50 nm, and macropore with a diameter of 50 nm or more. In the present invention, the adsorbent preferably has micropores. From the standpoint of adsorbing and removing target substances of various sizes, it is preferable in the present invention to use a micropore adsorbent and a mesopore adsorbent in combination, more preferably a micropore adsorbent, a mesopore adsorbent, and a macropore adsorbent in combination.

In the present invention, activated carbon may be used as the adsorbent. The activated carbon may be one obtained by carbonizing plant materials (such as wood, cellulose, sawdust, wood charcoal, coconut charcoal, and subai (charcoal powder)), coal materials (such as peat, ignite, brown coal, bituminous coal, anthracite, and tar), petroleum materials (such as petroleum residue, sulfuric acid sludge, and oil carbon), pulp waste fluid, or synthetic resin, followed by gas activation, as required (calcium chloride, magnesium chloride, zinc chloride, phosphoric acid, sulfuric acid, sodium hydroxide, potassium hydroxide, etc.).

In the present invention, laminar silicate may be used as the adsorbent. Examples of the laminar silicate include saponite, sauconite, stevensite, hectorite, margarite, talc, phlogopite, chrysotile, chlorite, vermiculite, kaolinite, muscovite, xanthophyllite, dickite, nacrite, pyrophyllite, montmorillonite, beidellite, nontronite, tetra silicic mica, sodium taeniolite, antigorite, and halloysite. The laminar silicate used in the present invention may be a commercially available product, such as Laponite XLG (synthetic hectorite-like substance from Laporte Inc., England), Laponite RD (synthetic hectorite-like substance from Laporte Inc., England), Thermabis (synthetic hectorite-like substance from Henkel, Germany), Sumecton SA-1 (saponite-like substance from Kunimine Industries), Bengel (natural montmorillonite from Hojun), Kunipia F (natural montmorillonite from Kunimine Industries), Veegum (natural hectorite from Vanderbilt Company, US), Dimonite (synthetic swellable mica from Topy Industries), Somasif (ME-100, synthetic swellable mica from Co-Op Chemical), SWN (synthetic smectite from Co-Op Chemical), and SWF (synthetic smectite from Co-Op Chemical).

In the present invention, zeolite may be used as the adsorbent. The zeolite may be a natural or synthetic zeolite. Examples of the natural zeolite usable in the present invention include analcime, chabazite, clinoptilolite, erionite, faujasite, mordenite, and phillipsite. Examples of the synthetic zeolite usable in the present invention include type-A zeolite, type-X zeolite, and type-Y zeolite.

In the present invention, cation-exchange resin may be used as the adsorbent. The cation-exchange resin may be, for example, a weakly acidic cation-exchange resin obtained by hydrolysis of a divinylbenzene-crosslinked acrylic acid ester or a methacrylic acid ester polymer, or a strongly acidic cation-exchange resin obtained by sulfonating a styrene-divinylbenzene copolymer.

In the present invention, anion-exchange resin may be used as the adsorbent. The anion-exchange resin used in the present invention may be, for example, one in which any of a primary amino group, a secondary amino group, a tertiary amino group, and a quaternary ammonium is bound to the aromatic ring of a styrene-divinylbenzene copolymer. The basicity of the anion-exchange resin increases as substituents on the amino group attached thereto increase, from a primary amino group, a secondary amino group, a tertiary amino group, and a quaternary ammonium salt.

In the present invention, chelate resin may be used as the adsorbent. The chelate resin used in the present invention may be, for example, one in which a functional group such as iminodiacetic acid, iminodipropionic acid, polyamine, aminophosphoric acid, isothiouronium, dithiocarbamic acid, and glucamine is introduced. The chelate resin used in the present invention may be a commercially available product, including, Diaion (for example, CR10, CR11, and CR20 from Mitsubishi Chemical Corporation), Amberlite (for example, IRC718 from Rohm and Haas Japan), DOWEX (Dow Chemical Company Japan), and Duolite (for example, CS-346, and ES-467 from Sumitomo Chemical Co., Ltd.).

As mentioned above, the present invention can improve adsorption efficiency with two or more fine adsorbent particles of different porosities. In addition to or instead of these adsorbents, two or more adsorbents having excellent adsorbability for different substances also may be used. Considering that a single adsorbent is not always effective for all the target substances contained in contaminated water, a wider variety of target substances in contaminated water can be adsorbed and removed with more than one adsorbent.

Different adsorbents have different adsorption specificities.

For example, when the target substance is an organic compound, it is effective to choose at least one adsorbent from activated carbon and zeolite, preferably activated carbon.

When the target substance is a cationic compound, it is effective to choose at least one adsorbent from zeolite, laminar silicate, cation exchange resin, and chelate resin, preferably at least one of zeolite and laminar silicate.

When the target substance is an anionic compound, it is effective to choose at least one adsorbent from hydrotalcite, schwertmannite, and anion exchange resin, preferably at least one of hydrotalcite and schwertmannite.

When the target substance is fluorine, it is effective to choose at least one adsorbent from hydroxyapatite, alumina, and zirconia, preferably alumina.

When the target substance is arsenic, it is effective to choose at least one adsorbent from activated carbon, alumina, hydrotalcite, and schwertmannite, preferably at least one of hydrotalcite and schwertmannite.

When the target substance is hexavalent chromium, it is effective to choose at least one adsorbent from activated carbon, zeolite, ferric hydroxide, hydrotalcite, and bentonite, preferably at least one of ferric hydroxide and hydrotalcite.

When the target substance is iodine, it is effective to choose at least one adsorbent from activated carbon, zeolite, hydrotalcite, boehmite, apatite, and crosslinked cyclodextrin-containing polymer, preferably zeolite.

When the target substance is cesium, it is effective to choose at least one adsorbent from activated carbon, zeolite, mordenite, vermiculite, iron ferrocyanide, and manganese oxide, preferably at least one of zeolite, mordenite, and iron ferrocyanide.

When the target substance is strontium, it is effective to choose at least one adsorbent from activated carbon, zeolite, polyantimonic acid, vermiculite, iron ferrocyanide, and montmorillonite, preferably at least one of zeolite and iron ferrocyanide.

When the method of the present invention is used to inexpensively, conveniently, and quickly obtain drinking water from well water, river water, lake water, and the like containing low-concentration contaminants, adsorbents for organic compounds, cationic compounds, anionic compounds, fluorine, arsenic, and hexavalent chromium are used preferably in a combination of two, more preferably three, further preferably four, so that more contaminant can be removed by a single operation from these waters, which are likely to contain different contaminants dissolved therein.

When the method of the present invention is used to remove radioactive compounds from sea water, cooling water, tap water, and the like dissolving trace amounts of radioisotopes such as iodine, cesium, and strontium, it is preferable to use a combination of an iodine adsorbent and a cesium adsorbent, more preferably a combination of an iodine adsorbent, a cesium adsorbent, and a strontium adsorbent.

The iron-based flocculant usable in the present invention is not particularly limited, and may be any iron-based flocculant that can produce an insoluble ferric hydroxide by reaction with an alkaline substance. Examples of iron-based flocculants preferred for use include ferric sulfate, ferric chloride, polyferric sulfate, and ferrous sulfate. It is further preferable to use ferric sulfate or ferric chloride. These may be used in a combination of two or more.

With the use of the iron-based flocculant, the resulting precipitate can have higher density and improved flocculation than when using an aluminum-based flocculant commonly used for water purification, and the precipitate can be produced in a wider pH range than when the aluminum-based flocculant is used.

The alkaline substance that reacts with the iron-based flocculant to produce an insoluble ferric hydroxide is not particularly limited in the present invention. Examples of the alkaline substance usable in the present invention include sodium carbonate, sodium hydroxide, and sodium bicarbonate. These may be used in a combination of two or more. The alkaline substance may be one containing calcium ions, such as hydrated lime (calcium hydroxide). However, purification leaves behind large amounts of calcium ions in the purified water. Because such water is not necessarily suited as drinking water, it is preferable to use a sodium ion-containing alkaline substance in the present invention. Calcium hydroxide is also not suited for use in the present invention intended to quickly purify water, because calcium hydroxide is poorly soluble in water and takes times to dissolve.

The purification agent contains the iron-based flocculant and the alkaline substance in a mass ratio of preferably 3:1 to 1:3, more preferably 2:1 to 1:2. Note, however, that the content range is not limited to these because the preferred range varies with the materials used.

The form of the iron-based flocculant and the alkaline substance is not particularly limited, and these may be used in powdery form or liquid form as may be decided according to the addition method used (described later).

In the present invention, a water-soluble polymer may be added to contaminated water, together with or separately from the purification agent. The water-soluble polymer serves as a polymer flocculant, and crosslinks the ferric hydroxide fine precipitate. This increases the size of the metal hydroxide flocs (flocculation), and makes it possible to reduce precipitation time, and improve ease of filtration.

The water-soluble polymer may be any of a nonionic water-soluble polymer, a cationic water-soluble polymer, and an anionic water-soluble polymer. These water-soluble polymers may be used either alone or in a combination of two or more.

Examples of the nonionic water-soluble polymer usable in the present invention include polyvinyl alcohol and derivatives thereof, starch and derivatives thereof, polyvinylpyrrolidone and derivatives thereof, cellulose derivatives such as carboxymethyl cellulose and hydroxymethyl cellulose, polyacrylamide and derivatives thereof, polymethacrylamide and derivatives thereof, gelatin, and casein.

Examples of the cationic water-soluble polymer usable in the present invention include chitosan, cationized polyvinyl alcohol, cationized starch, cationized polyacrylamide, cationized polymethacrylamide, polyamide-polyurea, polyethyleneimine, and copolymers of allylamine or salts thereof; epichlorohydrin-dialkylamine addition polymer; polymers of diallylalkylamine or salts thereof; polymers of diallyldialkylammonium salts; copolymers of diallylamine or salts thereof and sulfur dioxide; diallyldialkylammonium salt-sulfur dioxide copolymer; copolymers of a diallyldialkylammonium salt and diallylamine or salts or derivatives thereof; dialkylaminoethylacrylate quaternary salt polymer; dialkylaminoethylmethacrylate quaternary salt polymer; diallyldialkylammonium salt-acrylamide copolymer; and amine-carboxylic acid copolymer.

Examples of the anionic water-soluble polymer usable in the present invention include polystyrene sulfonate, polyalginic acid, carboxymethyl cellulose, carboxymethyl dextran, polyacrylic acid, partially hydrolyzed products of polyacrylamide, copolymerized maleic acid products, ligninsulfonic acid and derivatives thereof, oxyorganic acid, alkyl allyl sulfonic acid, water-soluble proteins and derivatives thereof, such as gelatin and hide glue. These anionic water-soluble polymers also may be used in the form of corresponding metal salts.

Preferred examples of the water-soluble polymer include polyacrylamide and derivatives thereof, partially hydrolyzed products of polyacrylamide, chitosan, carboxymethyl cellulose, gelatin, and polyacrylic acid. More preferred are polyacrylamide and derivatives thereof, and partially hydrolyzed products of polyacrylamide.

The molecular weight of the water-soluble polymer is preferably 50,000 or more, more preferably 100,000 or more, further preferably 1,000,000 or more, even more preferably 10,000,000 or more.

When a synthetic polymer is used as the water-soluble polymer, it is preferable to reduce the remaining amount of unreacted monomer. Specifically, when a synthetic polymer is used in the present invention, it is preferable that the amount of the residual monomer in water after the treatment based on the present invention be 5.0 μg/L or less, more preferably 1.0 μg/L or less, further preferably 0.5 μg/L or less.

In the present invention, the water-soluble polymer may be added to water in the form of a powder or an aqueous solution. When added as a powder, the water-soluble polymer may be added after being mixed with the purification agent beforehand.

In the present invention, an oxidizing agent may be added to contaminated water together with or separately from the purification agent. Use of an oxidizing agent makes it possible to sterilize microorganisms present in water, and oxidatively decompose water-soluble organic compounds. Examples of the oxidizing agent usable in the present invention include potassium permanganate, sodium persulfate, ammonium persulfate, chlorine, chlorine dioxide, sodium hypochlorite, calcium hypochlorite, sodium perchlorate, potassium perchlorate, ozone, hydrogen peroxide, and sodium percarbonate. The oxidizing agent is preferably any one of potassium permanganate, sodium hypochlorite, calcium hypochlorite, and sodium percarbonate. These oxidizing agents may be used either alone or in a combination of two or more.

The form of the oxidizing agent is not particularly limited, and the oxidizing agent may be added to water in the form of a powder, an aqueous solution, or a gas. When added as a powder, the oxidizing agent may be added after being mixed with the purification agent beforehand. When the oxidizing agent is used as a powder, it is preferable to use calcium perchlorate or sodium percarbonate, more preferably calcium perchlorate. Ozone and chlorine, which are gases at room temperature, are added to water preferably in gaseous form.

In the present invention, the three components of the purification agent may be mixed in advance and then added as a mixture, or may be added separately from each other. These may be added in the following forms.

Addition method 1: The adsorbent is added simultaneously with the iron-based flocculant and the alkaline substance added in powdery form.
Addition method 2: The adsorbent is added to, and dispersed throughout water before adding the iron-based flocculant and the alkaline substance in powdery form.
Addition method 3: The adsorbent is added to, and dispersed throughout water before adding the iron-based flocculant and the alkaline substance in liquid form.
Addition method 4: The adsorbent is added to, and dispersed throughout water before adding the iron-based flocculant in liquid form and the alkaline substance in powdery form.

Addition method 1 is preferred from the standpoint of containing the adsorbent, the iron-based flocculant, and the alkaline substance in a single pack, and simplifying the addition procedure. From the standpoint of effective adsorption with less amount of adsorbent, it is preferable to use addition methods 2 to 4, in which the adsorbent is added first in a first step, before the iron-based flocculant and the alkali are added in a second step after the adsorbent has sufficiently adsorbed the target substance.

When addition method 1 is used to purity water, uniform mixing of the adsorbent, the iron-based flocculant, and the alkaline substance can be effectively achieved in powdery form when these components have substantially the same particle size. By simultaneously adding the powdery uniform mixture of the adsorbent, the iron-based flocculant, and the alkaline substance to water, these components can mix without creating local concentration distributions. In this way, uniform precipitate formation can be realized in the whole system, and the target substance can be efficiently removed. It is therefore preferable in this addition form that the iron-based flocculant and the alkaline substance have the same particle sizes as the adsorbent, specifically 10 nm to 500 μm, more preferably less than 500 μm, further preferably 50 nm to 100 μm, even more preferably 75 nm to 50 μm, even further preferably 100 nm to 15 μm.

For effective water purification with less adsorbent, as describe above, it is preferable in the present invention to add the adsorbent first in a first step, and then add the iron-based flocculant and the alkali in a second step after the adsorbent has sufficiently adsorbed the target substance. After various studies, the present inventor found that dispersing the adsorbent in the presence of the water-soluble polymer was effective for uniformly dispersing the adsorbent in a short time period. When the water-soluble polymer is used in the present invention, it is therefore preferable to add the water-soluble polymer in a first step, and then add the adsorbent in a second step, before adding the iron-based flocculant and the alkali in a third step after the adsorbent has sufficiently adsorbed the target substance.

The adsorbent added to contaminated water adsorbs the contaminants in contaminated water, and the insoluble ferric hydroxide produced by reaction of the iron-based flocculant and the alkaline substance surrounds the adsorbent and forms flocs. The flocs have a size with an average particle diameter of about 0.5 mm to 5 mm. Larger flocs are more easily removed from water, and improve settling efficiency. In order to form large flocs, it is desirable to stir water after adding the purification agent. In the present invention, water is stirred for preferably 2 minutes or more, more preferably 2 minutes and 30 seconds or more, further preferably 5 minutes or more, even more preferably 10 minutes or more. The floc size depends on the stir time. The flocs can have the maximum size when water is stirred for 10 minutes or more. This makes the filtration easier.

The flocs in water settle under their own weight, and deposit as a contaminant-containing sludge at the bottom of a container. The supernatant water and the sludge can be inexpensively and conveniently separated from each other without using a special device. For example, the sludge is preferably filtered with a fabric or sand, more preferably a fabric.

The purified water after the removal of the sludge may be subjected to a further treatment.

The treated water may be irradiated with UV rays. The microorganisms present in water can be sterilized by this procedure.

The pH of the treated water may be adjusted for different purposes. For example, the pH of the treated water may be brought to 5.0 to 9.0, a preferred pH range for drinking water, to obtain water usable as drinking water. For use as drinking water, the water is brought to more preferably pH 5.8 to 8.6, even more preferably 6.5 to 7.5.

The method of the present invention may be used for production of drinking water. The method of the present invention can remove contaminants to levels usable as drinking water, without using electricity, and is particularly useful as a method of obtaining drinking water in developing countries where electricity is not readily available. Further, the method of the present invention is useful not only in developing countries, but in places where the waterworks system is destroyed by a disaster such as an earthquake, or in areas where there is no water supply such as in climbing and camping sites.

The method of the present invention also can be used to remove radioactive compounds from sea water, cooling water, tap water, and the like dissolving trace amounts of radioisotopes such as iodine, cesium, and strontium. When purifying sea water dissolving trace amounts of radioisotopes such as iodine, cesium, and strontium, it is not necessarily required to remove sodium chloride, magnesium chloride, magnesium sulfate, calcium sulfate, potassium chloride, and the like naturally dissolved in sea water itself, and it is preferable to selectively remove elements such as iodine, cesium, and strontium, including radioisotopes of these elements.

### EXAMPLES

The present invention is described below in greater detail using Examples. Materials, reagents, amounts, proportions, procedures, and other conditions used in the following Examples may be appropriately varied, provided that such changes do not depart from the gist of the present invention. Accordingly, the scope of the present invention is not limited by the following specific examples.

### 1. Example 1

### (1) Preparation of Mixed Flocculants 00 to 03

Mixed flocculants 00 to 03 of the compositions presented in the table below were prepared.

TABLE 1
Composition of mixed flocculant (for purification of 10-L water)

| | Metal salt | | | | Potassium |
|---|---|---|---|---|---|
| | (iron/aluminum-based | Sodium carbonate | | Calcium hypochlorite | permanganate |
| | flocculant) | (alkaline substance) | Water-soluble polymer | (oxidizing agent) | (oxidizing agent) |
| Mixed flocculant 00 | Ferric chloride | None | Polyacrylamide A | 0.01 g | 0.001 g |
| | 2.0 g | | 0.1250 g | | |
| Mixed flocculant 01 | Ferric chloride | 2.0 g | Polyacrylamide A | 0.01 g | 0.001 g |
| | 2.0 g | | 0.1250 g | | |
| Mixed flocculant 02 | Ferric sulfate | 2.0 g | Polyacrylamide B | None | 0.001 g |
| | 2.0 g | | 0.0125 g | | |
| Mixed flocculant 03 | Aluminum sulfate | 1.4 g | Polyacrylamide B | None | None |
| | 2.0 g | | 0.0500 g | | |

Polyacrylamide A: Polyacrylamide from Polysciences, Inc.; molecular weight 18,000,000
Polyacrylamide B: Sumifloc FA-70 from MT AquaPolymer; molecular weight 18,000,000

### (2) Preparation of Adsorbents

Activated carbons A to D having the average particle sizes presented in the table below were prepared, and used as adsorbents. Average particle size was determined from the mean value of the sphere-equivalent diameters of the particle forms observed under a light microscope or a transmission electron microscope.

TABLE 2
Average particle size of adsorbent, and dispersibility in water

| Adsorbent | Property | Dispersibility in water |
|---|---|---|
| Activated carbon A | Average particle | Dispersed throughout the system |
| | size 10 μm | after stirring, settled after 24 |
| | | hours |
| Activated carbon B | Average particle | Dispersed throughout the system |
| | size 20 μm | after stirring, settled after 12 |
| | | hours |
| Activated carbon C | Average particle | Did not disperse after stirring, |
| | size 3000 μm | but settled |
| Activated carbon D | Average particle | Did not disperse after stirring, |
| | size 6000 μm | but settled |

### (3) Evaluation of Removal Performance Against Methylene Blue (MB)

Methylene blue (MB) was chosen as the water-soluble compound. The mixed flocculant 01 and any of the activated carbons A to D (adsorbents) were used in the combinations shown in the table below. These components were then examined for their performance in removal of methylene blue from an aqueous solution.

Specifically, the mixed flocculant (207 mg) and the adsorbent (250 mg) were simultaneously added to 500 mL of an aqueous solution containing 600 ppm of methylene blue, and the mixture was stirred for 10 min. The stirring caused formation of a ferric hydroxide precipitate with the activated carbon. For each sample, the supernatant liquid was sampled after 5 min, 60 min, and 24 h from the end of the stirring, and the methylene blue concentration was calculated from the absorbance. The results are presented in the table below.

TABLE 3
Removal performance with iron-based flocculant and adsorbent used in combination

| | | | MB concentration | MB concentration | MB concentration | MB concentration | |
|---|---|---|---|---|---|---|---|
| | Mixed flocculant | Adsorbent | (before treatment) | (after 5 min) | (after 60 min) | (after 24 h) | Note |
| Sample 01 | None | None | 600 ppm | 600 ppm | 600 ppm | 600 ppm | Com. Ex. |
| Sample 02 | Mixed flocculant 01 | None | 600 ppm | 500 ppm | 450 ppm | 400 ppm | Com. Ex. |
| Sample 03 | Mixed flocculant 01 | Activated | 600 ppm | 50 ppm | 0 ppm | 0 ppm | Present |
| | | carbon A | | | | | invention |
| Sample 04 | Mixed flocculant 01 | Activated | 600 ppm | 100 ppm | 50 ppm | 0 ppm | Present |
| | | carbon B | | | | | invention |
| Sample 05 | Mixed flocculant 01 | Activated | 600 ppm | 500 ppm | 350 ppm | 200 ppm | Com. Ex. |
| | | carbon C | | | | | |
| Sample 06 | Mixed flocculant 01 | Activated | 600 ppm | 500 ppm | 400 ppm | 200 ppm | Com. Ex. |
| | | carbon D | | | | | |

Samples 03 and 04 of the present invention in which activated carbon A or B with an average particle size of 100 μm or less was used as the adsorbent were shown to very quickly remove the methylene blue compared to samples 05 and 06 in which activated carbon C or D with an average particle size of 100 μm or more was used as the adsorbent. The result thus demonstrated the effectiveness of the present invention.

No precipitate was formed after 10-min stirring of a sample prepared by adding 107 mg of mixed flocculant 00 to 500 mL of deionized water. On the other hand, a brownish-red precipitate and a colorless transparent supernatant were obtained after 5-min stirring of a sample prepared by adding 207 mg of mixed flocculant 01 to 500 mL of deionized water.

These results demonstrated that addition of the alkaline substance was necessary for obtaining a precipitate of the ferric hydroxide representing the main component of the flocculant.

### 2. Example 2

### Effect of Inorganic Flocculants

The mixed flocculants 01 to 03 and the activated carbon A (adsorbent) were used in the combinations shown in the table below, and were examined for their performance in removal of methylene blue from an aqueous solution. The aqueous solution was prepared as a 500-mL aqueous solution of pH 6.9 or pH 8.5 containing 600 ppm of methylene blue. For each sample, the adsorbent was added in 250 mg, and as the mixed flocculant, flocculant 01 (206.3 mg) was added for samples 08 and 11, flocculant 02 (206.3 mg) was added for samples 09 and 12, and flocculant 03 (172.5 mg) was added for samples 10 and 13.

The adsorbent and each mixed flocculant were simultaneously added to the aqueous solution, and the mixture was stirred for 10 min. The stirring caused formation of a ferric hydroxide precipitate with activated carbon (samples 9, 10, 11, and 12), and an aluminum hydroxide precipitate with activated carbon (samples 10 and 14). After 60 min, each sample was filtered with a cotton fabric to separate the precipitate, and the methylene blue concentration was calculated from the absorbance of the resulting filtrate. The results are presented in the table below.

TABLE 4
Effect of flocculant on removal performance of methylene blue (MB) from aqueous solution

| | | | | MB concentration | MB concentration | |
|---|---|---|---|---|---|---|
| | Mixed flocculant | Adsorbent | pH | (before treatment) | (after 60 min) | Note |
| Sample 07 | None | Activated carbon A | 6.9 | 600 ppm | Immeasurable | Com. Ex. |
| Sample 08 | Mixed flocculant 01 | Activated carbon A | 6.9 | 600 ppm | 0 ppm | Present invention |
| Sample 09 | Mixed flocculant 02 | Activated carbon A | 6.9 | 600 ppm | 0 ppm | Present invention |
| Sample 10 | Mixed flocculant 03 | Activated carbon A | 6.9 | 600 ppm | 0 ppm | Com. Ex. |
| Sample 11 | None | Activated carbon A | 8.5 | 600 ppm | Immeasurable | Com. Ex. |
| Sample 12 | Mixed flocculant 01 | Activated carbon A | 8.5 | 600 ppm | 0 ppm | Present invention |
| Sample 13 | Mixed flocculant 02 | Activated carbon A | 8.5 | 600 ppm | 0 ppm | Present invention |
| Sample 14 | Mixed flocculant 03 | Activated carbon A | 8.5 | 600 ppm | Immeasurable | Com. Ex. |

In samples 07 and 11 that contained only activated carbon A having an average particle size of 10 μm and that did not contain the flocculant, the activated carbon A was dispersed throughout the system after 60 min from the addition, and also in the filtrate after the filtration performed with a cotton fabric. It was accordingly not possible to measure the methylene blue concentration. In contrast, the methylene blue was completely adsorbed by the activated carbon and precipitated 60 min after the treatment, and the precipitate was completely filtered out with the cotton fabric and the filtrate was completely free of methylene blue in the examples of the present invention, specifically in samples 08 and 12 in which the ferric chloride-containing mixed flocculant 01 and the activated carbon A were used in combination, and in samples 09 and 13 in which the ferric sulfate-containing mixed flocculant 02 and the activated carbon A were used in combination. These results demonstrated the effectiveness of the present invention.

On the other hand, in Comparative Examples in which the aluminum sulfate-containing mixed flocculant 03 and the activated carbon A were used in combination, the flocculation and settling by aluminum hydroxide was insufficient at pH 8.5, and the activated carbon partially remained in the state of being dispersed, though methylene blue was completely removed at pH 6.9. These results demonstrated that the dispersed activated carbon remained in the filtrate even after the filtration performed with a cotton fabric.

### 3. Example 3

### Arsenic Removal Performance

Arsenic(III) was chosen as the water-soluble compound. The mixed flocculant 01 and the activated carbon A were used in the combinations shown in the table below. These components were then examined for their performance in removal of arsenic from an aqueous solution.

Specifically, the mixed flocculant 01 (207 mg) and the activated carbon A (adsorbent; 250 mg) were simultaneously added to 500 mL of an aqueous solution containing 250 ppb of arsenic, and the mixture was stirred for 10 min. The stirring caused formation of a ferric hydroxide precipitate with the adsorbent. For each sample, the supernatant liquid was sampled after 10 min from the end of the stirring, and the arsenic concentration was calculated by atomic absorption spectrometry. The results are presented in the table below.

TABLE 5
Removal performance of arsenic from aqueous solution

| | | | Arsenic | Arsenic | |
|---|---|---|---|---|---|
| | Mixed | | concentration | concentration | |
| | flocculant | Adsorbent | (before treatment) | (after 10 min) | Note |
| Sample 15 | None | None | 250 ppb | 250 ppb | Com. Ex. |
| Sample 16 | None | Activated | 250 ppb | 165 ppb | Com. Ex. |
| | | carbon A | | | |
| Sample 17 | Mixed | None | 250 ppb | 3 ppb | Com. Ex. |
| | flocculant 01 | | | | |
| Sample 18 | Mixed | Activated | 250 ppb | 0 ppb | Present |
| | flocculant 01 | carbon A | | | invention |

Sample 17 involving addition of mixed flocculant 01 alone showed excellent arsenic removal performance. However, addition of mixed flocculant 01 and activated carbon A was shown to achieve complete removal of arsenic as in sample 18 representing an example of the present invention. The result demonstrated the effectiveness of the present invention.

### 4. Example 4

### Relationship Between Stir Time and Ease of Settling

The mixed flocculant 01 and the activated carbon A were used in combination, and the relationship between the stir time and the ease of settling of methylene blue in an aqueous solution was examined. The aqueous solution was prepared as a 500-mL aqueous solution of pH 6.9 containing 500 ppm of methylene blue. The mixed flocculant 01 (207 mg) and the adsorbent (activated carbon A; 250 mg) were simultaneously added to the aqueous solution, and each mixture was stirred for the time period presented in the table below to prepare a sample.

Each sample was visually observed for the extent of adsorbent dispersion 5 min, 60 min, and 24 h after the end of the stirring, and evaluated according to the following criteria.

A: Supernatant was completely colorless and transparent
B: Most of the activated carbon settled, and activated carbon partially remained dispersed
C: Most of the activated carbon was dispersed, and activated carbon partially settled
D: Activated carbon was completely dispersed

The results are presented in the table below.

TABLE 6
Effect of stir time on adsorbent settling rate

| | | | | 5 Min after | 60 Min after | 24 H after | |
|---|---|---|---|---|---|---|---|
| | Mixed flocculant | Adsorbent | Stir time | stirring | stirring | stirring | Note |
| Sample 19 | Mixed flocculant 01 | Activated carbon A | None | D | D | C | Present invention |
| Sample 20 | Mixed flocculant 01 | Activated carbon A | 30 sec | D | D | B | Present invention |
| Sample 21 | Mixed flocculant 01 | Activated carbon A | 60 sec | D | C | B | Present invention |
| Sample 22 | Mixed flocculant 01 | Activated carbon A | 90 sec | C | B | A | Present invention |
| Sample 23 | Mixed flocculant 01 | Activated carbon A | 120 sec | B | B | A | Present invention |
| Sample 24 | Mixed flocculant 01 | Activated carbon A | 150 sec | A | A | A | Present invention |
| Sample 25 | Mixed flocculant 01 | Activated carbon A | 180 sec | A | A | A | Present invention |

It was demonstrated that increasing the stir time was effective for effectively settling the adsorbent. It can be understood that 2 or more minutes of stirring can greatly improve the settling rate, and that the settling rate almost reaches its upper limit after two and a half minutes or more of stirring.

### 5. Example 5

### Effect of Inorganic Flocculants

Activated carbon A (250 mg) was added to a 500-mL aqueous solution of pH 6.9 containing 500 ppm of methylene blue. Aqueous solutions of ferric sulfate, sodium carbonate, and polyacrylamide B were then separately added in a manner allowing the mixed flocculant 02 to be contained in the predetermined amounts shown in the table below. Each mixture was stirred for 10 min. The samples were visually observed for the extent of activated carbon dispersion 60 min after the end of the stirring, and evaluated according to the following criteria.

A: Supernatant was completely colorless and transparent
B: Most of the activated carbon settled, and activated carbon partially remained dispersed
C: Most of the activated carbon was dispersed, and activated carbon partially settled
D: Activated carbon was completely dispersed

The results are presented in the table below.

TABLE 7
Effect of mixed flocculant on removal performance of methylene blue (MB) from aqueous solution

| | Activated | Mixed | | Mass percentage of | Ease of | | |
|---|---|---|---|---|---|---|---|
| | carbon A | flocculant 02 | | activated carbon A | settling | Sludge formation | Note |
| Sample 26 | 250 mg | 400 | mg | 38.5% | A | Large | Com. Ex. |
| Sample 27 | 250 mg | 200 | mg | 55.6% | A | Moderate | Present invention |
| Sample 28 | 250 mg | 100 | mg | 71.4% | A | Small | Present invention |
| Sample 29 | 250 mg | 40 | mg | 86.2% | A | Small | Present invention |
| Sample 30 | 250 mg | 20 | mg | 92.6% | B | Small | Com. Ex. |
| Sample 31 | 250 mg | 10 | mg | 96.0% | D | Not observed | Com. Ex. |
| Sample 32 | 250 mg | 5 | mg | 98.0% | D | Not observed | Com. Ex. |

| | | | | | | |
|---|---|---|---|---|---|---|
| Sample 33 | 250 mg | None | 100% | D | Not observed | Com. Ex. |

In sample 26 that had the activated carbon A mass percentage of 40% or less, large amounts of sludge were generated, though methylene blue was completely removed, and a colorless transparent supernatant was obtained. On the other hand, in samples 31 to 33 in which the mass percentage of activated carbon A was 95% or more, the activated carbon A was completely dispersed in water, and was not easily removed. In contrast, in samples 27 to 30 in which the mass percentage of activated carbon A was 40% to 95%, the activated carbon almost completely settled and flocculated. Particularly, in samples 28 and 29 in which the mass percentage of activated carbon A was 60% to 90%, methylene blue was completely removed, and a colorless transparent supernatant was obtained, without much sludge formation. These results demonstrated the effectiveness of the present invention.

### 6. Example 6

### Iodine Removal Performance from Water

Iodine was chosen as the water-soluble compound. The flocculant and the adsorbent were used in combination to examine iodine removal performance from an aqueous solution.

Mixed flocculant 02 (207 mg) and the adsorbent (250 mg) were simultaneously added to 500 mL of water containing a 0.05 mol iodine solution (1,000 μL). The mixture was stirred for 10 min. The stirring caused formation of a ferric hydroxide precipitate with the activated carbon. The iodine concentration in the supernatant was calculated from the absorbances of diluted solutions. The results are presented in the table below.

TABLE 8
Iodine removal performance from aqueous solution with
iron-based flocculant and adsorbent used in combination

| | | | Iodine | Iodine | |
|---|---|---|---|---|---|
| | Mixed | | concentration | concentration | |
| | flocculant | Adsorbent | (before treatment) | (after 5 min) | Note |
| Sample 34 | Mixed | None | 1 × 10⁻⁴ mol | 1 × 10⁻⁴ mol | Com. Ex. |
| | flocculant 02 | | | | |
| Sample 35 | Mixed | Activated | 1 × 10⁻⁴ mol | 0 mol | Present |
| | flocculant 02 | carbon A | | | Invention |
| Sample 36 | Mixed | Activated | 1 × 10⁻⁴ mol | 0.99 × 10⁻⁴ mol | Com. Ex. |
| | flocculant 02 | carbon C | | | |

Highly effective iodine removal was confirmed only in sample 35 of the present invention in which the adsorbent (activated carbon A) having an average particle size of 100 μm or less was used. The result demonstrated the effectiveness of the present invention.

### 7. Example 7

### Iodine Removal Performance from 3.5% NaCl Aqueous Solution

Experiments were conducted in the same manner as in Example 6, except that a 3.5% NaCl aqueous solution was used in place of water. The iodine concentrations before and after the treatment were then confirmed. The results are presented in the table below.

TABLE 9
Iodine removal performance from 3.5% NaCl aqueous solution with
iron-based flocculant and adsorbent used in combination

| | | | Iodine | Iodine | |
|---|---|---|---|---|---|
| | Mixed | | concentration | concentration | |
| | flocculant | Adsorbent | (before treatment) | (after 5 min) | Note |
| Sample 37 | Mixed | None | 1 × 10⁻⁴ mol | 1 × 10⁻⁴ mol | Com. Ex. |
| | flocculant 02 | | | | |
| Sample 38 | Mixed | Activated | 1 × 10⁻⁴ mol | 0 mol | Present |
| | flocculant 02 | carbon A | | | Invention |
| Sample 39 | Mixed | Activated | 1 × 10⁻⁴ mol | 0.98 × 10⁻⁴ mol | Com. Ex. |
| | flocculant 02 | carbon C | | | |

Highly effective iodine removal was confirmed only in sample 38 of the present invention in which the adsorbent having an average particle size of 100 μm or less was used for the iodine solution prepared from the 3.5% NaCl aqueous solution having the same level of salt concentration as sea water. The result demonstrated the effectiveness of the present invention.

### 8. Example 8

### Cesium Removal Performance from Water

Cesium was chosen as the water-soluble compound. The mixed flocculant and the adsorbent were used in combination to examine cesium removal performance from an aqueous solution.

Mixed flocculant 02 (207 mg) and mordenite (250 mg) having a particle size of 2 μm were simultaneously added to 500 mL of an aqueous solution containing cesium carbonate. The mixture was stirred for 10 min. The stirring caused formation of a ferric hydroxide precipitate with the mordenite. The cesium concentration in the supernatant was measured by ICP-MS analysis after diluting samples 10,000 times. The results are presented in the table below.

TABLE 10
Cesium removal performance from aqueous solution
with flocculant and adsorbent used in combination

| | | | Cesium | Cesium | |
|---|---|---|---|---|---|
| | | | concentra- | concentra- | |
| | Mixed | | tion (before | tion (after | |
| | flocculant | Adsorbent | treatment) | 5 min) | Note |
| Sample | Mixed | None | 86.4 ppm | 83.2 ppm | Com. Ex. |
| 40 | flocculant 02 | | | | |
| Sample | Mixed | Mordenite | 86.4 ppm | 19.0 ppm | Present |
| 41 | flocculant 02 | | | | Invention |

Effective cesium removal was confirmed in sample 41 of the present invention in which the adsorbent having an average particle size of 100 μm or less was used. The result demonstrated the effectiveness of the present invention.

### INDUSTRIAL APPLICABILITY

The present invention can provide a method for conveniently and efficiently purifying contaminated water. The method of the present invention is useful as a method of purifying contaminated water and obtaining daily water and drinking water in less-developed countries, and also as a method of treating drained water from industrial plants and electrical power plants.

While the present invention has been described in detail and with reference to specific embodiments thereof, it will be apparent to one skilled in the art that various changes and modifications can be made therein without departing from the spirit and scope thereof.

The present disclosure relates to the subject matter contained in International Application No. PCT/JP2012/064498, filed Jun. 6, 2012; and Japanese Application No. 2011-136206, filed Jun. 20, 2011, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A water purification method comprising:
adding a purification agent to water having a contaminant concentration of 1 μg/L to 10 g/L, the purification agent containing an adsorbent having an average particle size of 100 nm to 500 μm, an iron-based flocculant, and an alkaline substance;
causing the adsorbent to adsorb at least a part of the contaminants in water;
settling the adsorbent with the adsorbed contaminants under the effect of a water-insoluble ferric hydroxide produced by reaction of the iron-based flocculant and the alkaline substance to form a sediment; and
removing the sediment from water,
wherein the purification agent is added in an amount of 0.01 g to 20 g per liter of water.

2. The water purification method according to claim 1, wherein the proportion of the adsorbent in the total mass of the purification agent is 40 mass % to 95 mass %.

3. The water purification method according to claim 1, wherein a water-soluble polymer is added together with the purification agent or separately from the purification agent.

4. The water purification method according to claim 1, wherein the sediment is removed from water by filtration with a fabric or sand.

5. The water purification method according to claim 1, wherein the adsorbent contains at least one of activated carbon and zeolite, and adsorbs at least an organic compound in water.

6. The water purification method according to claim 1, wherein the adsorbent contains at least one of zeolite, laminar silicate, cation exchange resin, and chelate resin, and adsorbs at least a cationic compound in water.

7. The water purification method according to claim 1, wherein the adsorbent contains at least one of hydrotalcite, schwertmannite, and anion exchange resin, and adsorbs at least an anionic compound in water.

8. The water purification method according to claim 1, wherein the adsorbent contains at least one of hydroxyapatite, alumina, and zirconia, and adsorbs at least fluorine in water.

9. The water purification method according to claim 1, wherein the adsorbent contains at least one of activated carbon, alumina, hydrotalcite, and schwertmannite, and adsorbs at least arsenic in water.

10. The water purification method according to claim 1, wherein the adsorbent contains at least one of activated carbon, zeolite, ferric hydroxide, hydrotalcite, and bentonite, and adsorbs at least hexavalent chromium in water.

11. The water purification method according to claim 1, wherein the adsorbent contains at least one of zeolite, hydrotalcite, boehmite, apatite, and crosslinked cyclodextrin-containing polymer, and adsorbs at least iodine in water.

12. The water purification method according to claim 1, wherein the adsorbent contains at least one of activated carbon, zeolite, mordenite, vermiculite, iron ferrocyanide, and manganese oxide, and adsorbs at least cesium in water.

13. The water purification method according to claim 1, wherein the adsorbent contains at least one of activated carbon, zeolite, polyantimonic acid, vermiculite, iron ferrocyanide, and montmorillonite, and adsorbs at least strontium in water.

14. The water purification method according to claim 1, wherein the adsorbent is used in a combination of two or more.

15. The water purification method according to claim 1, wherein the iron-based flocculant contains at least one of ferric sulfate, ferric chloride, polyferric sulfate, and ferrous sulfate.

16. The water purification method according to claim 1, wherein the iron-based flocculant and the alkaline substance are each a powder having an average particle size of 100 nm to 500 μm.

17. The water purification method according to claim 1, wherein an oxidizing agent is added together with the purification agent or separately from the purification agent.

18. The water purification method according to claim 1, wherein the water is brought to pH 5.0 to pH 9.0 after removing the sediment.

19. The water purification method according to claim 1, wherein the purified water is used as drinking water.
